(19) United States
(12) Patent Application Publication
(10) Pub. No.: US 2003/0098873 A1
(43) Pub. Date: May 29, 2003

(54) Flat panel display device and driving method for same

(75) Inventor: Seong Hak Moon, Yongin (KR)

Correspondence Address: FLESHNER & KIM, LLP, P.O. BOX 221200, CHANTILLY, VA, 20153, US

(73) Assignee: LG Electronics Inc.

(21) Appl. No.: 10/216,926

(22) Filed: Aug. 13, 2002

(30) Foreign Application Priority Data
Nov. 23, 2001 (KR) 73225/2001

(51) Int. Cl. G09G 5/10

(52) U.S. Cl. 345/690

(57) ABSTRACT

A driving method for flat panel display device, capable of lowering a peak current which is generated in driving a flat field emission display, supplies a data pulse to a data line and supplies a scan pulse to a scan line, being synchronized with the data line, and the method is conducted by supplying a data pulse having a predetermined tilt to the data line or supplying a scan pulse having a predetermined tilt to the scan line.

### BACKGROUND OF THE INVENTION

1. Field of the Invention

The present invention relates to a flat panel display device and a driving method for the same and particularly, to a flat panel display device and a driving method for the same, capable of displaying uniform luminance.

2. Description of the Background Art

Recently, various flat panel display devices which can reduce weight and volume of a Cathode Ray Tube (hereinafter, as CRT) have been developed. The flat panel display device is divided to a Liquid Crystal Display (hereinafter, as LCD), Field Emission Display (hereinafter, as FED), Plasma Display Panel (hereinafter, as PDP), Electro-Luminescence (hereinafter, as EL) and the like. To improve the displaying quality of the flat panel display device, researches for increasing luminescence, contrast and color purity are actively in progress.

The FED is divided into a tip type FED which emits electron using the tunnel effect by concentrating a high electric field in the acute emitter, and a metal insulator metal (hereinafter, as MIM) FED which emits electron by concentrating a high electric field in rating a high electric field in rea.

FIG. 1 is a perspective view showing a tip type field emission display device in accordance with the conventional art.

FIG. 2 is a cross-sectional view showing the tip type field emission display device shown in FIG. 1.

As shown in FIGS. 1 and 2, the FED includes an upper glass substrate 2 in which an anode electrode 4 and phosphor 6 are, laminated and a field emission array 32 which is formed on a lower glass substrate 8. The field emission array 32 includes a cathode electrode 10 and resistance layer 12 which are formed on the lower glass substrate 8, insulation layer 14 and emitter 22 which are formed on the resistance layer 12, and a gate electrode 16 which is formed on the gate insulation layer 14.

The cathode electrode 10 supplies an electric current to the emitter 22 and the resistance layer 12 restricts an overcurrent which is applied to the emitter 22 from the cathode electrode 10, thus to supply a uniform current to the emitter 22.

The gate insulation layer 14 insulates between the cathode electrode 10 and gate electrode 16. The gate electrode 16 is used as a fetching electrode for fetching electrons. A spacer 40 is installed between the upper glass substrate 2 and lower glass substrate 8.

The spacer 40 supports the upper glass substrate 2 and lower glass substrate 8 to maintain the high vacuum condition between the upper glass substrate 2 and lower glass substrate 8.

To display a picture on the display device, firstly, a cathode electrode of a negative polarity (minus −) is applied to the cathode electrode 10 and an anode voltage of a positive polarity (plus +) is applied to the anode electrode 4. A gate voltage of a negative polarity (−) is applied to the gate electrode 16. Then, an electron beam 30 which is emitted from the emitter 22 is collided into red, green and blue phosphor 6 and excite the phosphor 6. At this time, according to the phosphor, a visible light with a color among the red, green and blue colors is emitted.

In the tip type FED, discharging amount of electron is determined according to the characteristic of the emitter which is used for electron discharging. Therefore, every emitter must be manufactured uniformly, but with the present manufacturing process, it is difficult to manufacture an emitter uniformly and much time is taken to manufacture such emitter.

Also, in the tip type FED, since the electron is emitted from the acute emitter and it is difficult to reduce the gap between the cathode and gate electrodes 10 and 16, a voltage of several tens to hundreds volts must be applied to between the electrodes.

Therefore, much amount of power is consumed by the voltage which is applied to the cathode electrode 10 and gate electrode 16.

FIGS. 3A to 3B are views showing a pixel cell of the flat panel field emission display device in accordance with the conventional art.

As shown in FIGS. 3A to 3B, each pixel cell of the flat FED includes an upper substrate 42 in which an anode electrode 44 and phosphor 46 are laminated, and a field emission array 56 which is formed on a lower substrate 48.

To display an image on the display device, a scan pulse of a negative polarity (−) is applied to the scan electrode 50 and a data pulse of a positive polarity (+) is applied to a data electrode 54. Then, the electrons are accelerated to the anode electrode 44 by tunneling from the scan electrode 50 to the data electrode 54. collision

The electrons excite the phosphor 46 by clashing into red, green and blue phosphor 46. At this time, according to the phosphor, a visible light with a color among the red, green and blue colors is generated.

Such flat FED can be driven with a lower voltage than that of the tip type FED, since the scan electrode 50 and data electrode 54 can be installed having a predetermined area and facing each other (thickness of the insulation layer can be processed by the thin film processing). That is, voltages of only several volts to several tens of volts are applied to the scan electrode 50 and data electrode 54 of the flat FED. Also, since the scan electrode 50 and data electrode 54 for emitting electrons, have a predetermined area, the scan electrode 50 and data electrode 54 can be manufactured by a simpler manufacturing process than that of the tip type FED.

FIG. 4 is a wave form chart showing a driving wave form which is supplied to the field emission display device in accordance with the conventional art.

As shown in FIG. 4, a scan pulse SP of a negative polarity (−) is sequentially applied to a scan line S of the conventional flat FED, and a data pulse DP of a positive polarity (+) which is synchronized with the scan pulse SP of the negative polarity (−) is supplied to the data line D. In the pixel cell to which the scan pulse SP and data pulse DP are supplied, electrons are emitted by the voltage difference between the scan pulse SP and data pulse DP. This will be described with reference to FIG. 5.

FIG. 5 is a view showing the field emission display device in which the pixel cells shown in FIGS. 3A to 3B are arranged in the matrix form.

As shown in FIG. 5, when a scan pulse SP of −5V is applied to the first scan line S1 and a data pulse DP of 5V is applied to the data line D, a voltage difference of 10V is generated in the first pixel cells P1 which are formed in the first scan line S1. Therefore, electrons are emitted from the first pixel cells P1 to which data pulse DP is supplied. At this time, respectively different data values are supplied to the cells D1 to Dn of the data line and accordingly, the pixel cells can be turned on or off. That is, the pixel cells at the position where the cells D1 to Dn of the scan line S1 and Data line cross each other are turned on or off according to the value of the data line.

At this time, the width and/or amplitude of the data pulse DP is set differently according to the gray scale. For instance, when a high gray scale is displayed, the width and/or amplitude of the data pulse DP is set wide or high when a high gray scale is displayed, and when a low gray scale is displayed, the width and/or amplitude of the data pulse DP is set narrow or low.

On the other hand, in the second to mth pixel cells P2˜Pm which are formed in the second to mth scan lines S2˜Sm, since 5V, that is just the data pulse DP is applied, electrons are not emitted.

Then, by repeating the above process, an image is displayed by driving the first to mth pixel cells P1˜Pm by sequentially applying the scan pulse SP and data pulse DP (DP designates a average value of the D1˜Dn) to the mth scan line Sm. After displaying the image, when a reset pulse RP of a positive polarity is applied to the first to mth scan lines S1˜Sm, the electric charges which are charged in the first to mth pixel cells P1˜Pm are removed.

However, different voltages are applied according to the position of the scan line in the conventional flat FED. That is, much amount of voltage drop is occurred since the scan line of the flat FED has a high resistance value. This will be described with reference to FIG. 6.

FIG. 6 is a view equivalently showing the pixel cell of the FED shown in FIG. 3. That is, it is supposed that 1 mA of current be supplied to the pixel cell 100 to which the scan pulse SP an data pulse DP are supplied.

As shown in FIG. 6, it is supposed that the resistance from the starting point of the first scan line S1 to the first switch 70 is R1 and the resistance from the starting point of the first scan line S1 to the second switch 72 is R2. It is supposed that the resistance from the starting point of the first scan line S1 to the third position 74 be R3.

Voltage drop of 1 mA×R1 is occurred in the first position 70 of the first scan line S1 by the Ohm's law (V=IR). Also, voltage drop of 4 mA×R2 is occurred in the second position 72 of the first scan line S1. Voltage drop of 100 mA×R3 is occurred in the third position 74 of the first scan line S1. This will be described with reference to FIG. 7.

FIG. 7 is a view showing a value of voltage which is applied to the scan electrode shown in FIG. 6.

As shown in FIG. 7, the voltage which is supplied to the scan line S1 is gradually lowered along from the first data line D1 to the nth data line Dn. When different voltages are applied to the positions of the scan lines S, pictures of different brightness are displayed. That is, left side portion of the screen is displayed brightly when white is displayed in the whole screen of the FED and on the other hand, right side portion of the screen is displayed darker than the left side portion. Particularly, such voltage dropping phenomenon is more remarkably occurred as the FED is fabricated larger.

As described above, in the flat FED of the conventional art, luminance of the whole screen was not uniform since different voltages are applied to the positions of the scan lines S.

### SUMMARY OF THE INVENTION

Therefore, an object of the present invention is to provide a flat panel display device and a driving method for the same, capable of displaying luminance of a whole screen uniformly.

To achieve these and other advantages and in accordance with the object of the present invention, as embodied and broadly described herein, there is provided a driving method for a flat panel display device, including the steps of sequentially supplying a scan pulse to a plurality of scan electrodes, and supplying a first data pulse which is synchronized with the scan pulse and has different voltage values to a plurality of data electrodes.

To achieve these and other advantages and in accordance with the object of the present invention, as embodied and broadly described herein, there is provided a flat panel display device, including a reference voltage generation unit for generating a reference voltage value, a scan driving unit for supplying a scan pulse to a scan electrode of the panel, a data driving unit which is synchronized with the scan pulse, for supplying a data pulse obtained by adding the reference voltage value, to a data electrode of a panel, and a timing control unit for controlling timing of the scan pulse.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing a tip type field emission display device in accordance with the conventional art;

FIG. 2 is a cross-sectional view showing the tip type field emission display device shown in FIG. 1;

FIGS. 3A to 3B are views showing a pixel cell of the flat panel field emission display device in accordance with the conventional art;

FIG. 4 is a wave form chart showing a driving wave form which is supplied to the field emission display device in accordance with the conventional art;

FIG. 5 is a view showing the field emission display device in which the pixel cells shown in FIGS. 3A to 3B are arranged in the matrix form;

FIG. 6 is a view equivalently showing the pixel cell of the FED shown in FIG. 3;

FIG. 7 is a view showing a value of voltage which is applied to the scan electrode shown in FIG. 6;

FIG. 8 is a block diagram showing a driving apparatus of the flat FED in accordance with the first embodiment of the present invention;

FIG. 9 is a view showing a reference voltage which is generated in the reference voltage signal generation unit shown in FIG. 8;

FIG. 10 is a view showing a data pulse which is applied to a data electrode by the driving apparatus shown in FIG. 8;

FIG. 11 is a view showing a voltage value which is applied to a scan electrode by the driving apparatus shown in FIG. 8;

FIG. 12 is a block diagram showing the reference voltage signal generation unit shown in FIG. 8 in detail;

FIG. 13 is a block diagram showing the driving apparatus of the flat FED in accordance with the second embodiment of the present invention;

FIG. 14 is a view showing the data pulse which is applied to the data electrode by the driving apparatus shown in FIG. 13;

FIG. 15 is a block diagram showing a voltage raising unit which is shown in FIG. 13 in detail;

FIGS. 16A to 16C are wave form views showing driving wave forms in accordance with the third embodiment of the present invention; and

FIG. 17 is a view showing a wave form of the scan pulse in accordance with the fourth embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

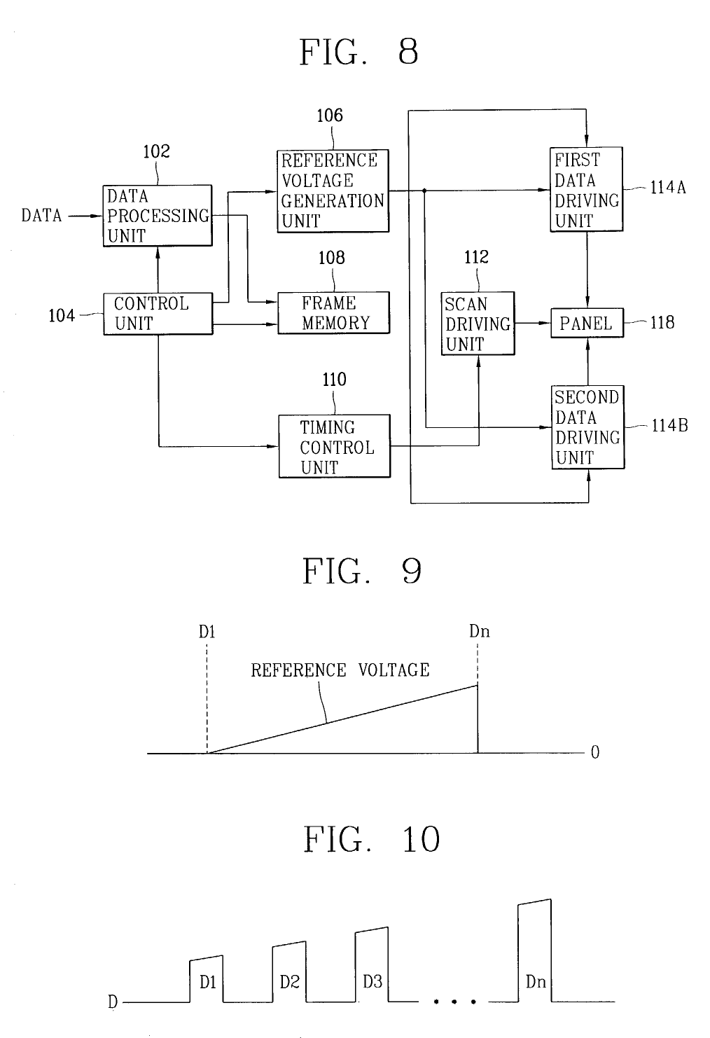

Hereinafter, preferred embodiments of a flat panel display and driving method for the same, capable of uniformly displaying luminance of a whole screen of a flat FED will be described in detail with reference to FIGS. 8 to 17.

FIG. 8 is a block diagram showing a driving apparatus of the flat FED in accordance with the first embodiment of the present invention.

As shown in FIG. 8, the flat FED in accordance with a first embodiment of the present invention includes a data processing unit 102 for supplying data supplied from the outside, a reference voltage generation unit 106 for generating a reference voltage having a predetermined tilt according to a control signal, a frame memory 108 for temporarily storing data corresponding to a frame from the data processing unit 102, first and second driving units 114A and 114B for supplying a data pulse by receiving the reference voltage and the stored data, a timing control unit 110 for generating a timing control signal for controlling timing of the scan pulse according to the control signal, a scan driving unit 112 for sequentially supplying a scan pulse to a panel 118 by controlling of the timing control signal, a control unit 104 for generating the control signal. Hereinafter, the operation of the driving unit of the flat FED will be described in detail with reference to FIGS. 9 and 10.

FIG. 9 is a view showing a reference voltage which is generated in the reference voltage signal generation unit shown in FIG. 8.

FIG. 10 is a view showing a data pulse which is applied to a data electrode by the driving unit shown in FIG. 8.

Firstly, the data processing unit 102 supplies the data supplied from the outside to the frame memory 108. The frame memory 108 receives a control signal which is outputted from the control unit 104, receives data corresponding to a frame from the data processing unit 102 and supplies the inputted data corresponding to a frame to the first and second data driving units 114A and 114B.

The reference voltage generation unit 106 generates a reference voltage having a predetermined tilt by receiving a control signal which is outputted from the control unit 104, as shown in FIG. 9.

The control unit 104 generates a control signal to control the data processing unit 102, reference voltage generation unit 106, frame memory 108 and timing control unit 110.

On the other hand, the timing control unit 110 generates a timing control signal by receiving a control signal which is outputted from the control unit 104 and supplies the timing control signal to the scan driving unit 112.

The scan driving unit 112 sequentially supplies a scan pulse to the panel 118 by receiving the timing control signal. At this time, the data driving units 114A and 114B supply the data (that is, data pulse) which is stored in the frame memory 108 to the panel 118 by receiving a reference voltage having the predetermined tilt.

The panel 118 displays a picture (image) corresponding to the gray scale value of the data pulse.

A value of voltage of a data pulse which is supplied to the first and second data driving units 114A and 114B is obtained by adding the voltage value of the reference value. Therefore, when data for displaying the whole screen of the FED as white is supplied to the first and second data driving units 114A and 114B, a different voltage is supplied to a data electrode D (data line) of the panel 118, as shown in FIG. 10. That is, a higher voltage is applied along from the first data electrode D1 to the nth data electrode Dn. In other words, since a reference voltage having a predetermined tilt is supplied as in FIG. 9 and a value obtained by adding the reference voltage and voltage of the data pulse is supplied to the panel 118, a different voltage is supplied to the data electrode D as shown in FIG. 10.

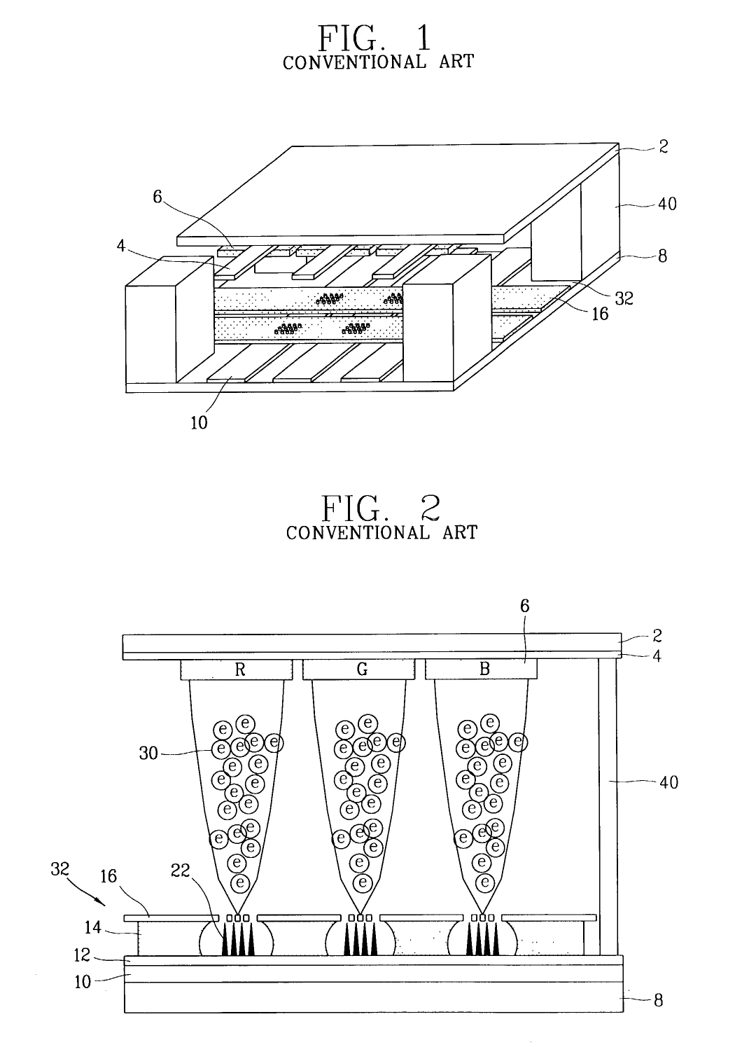

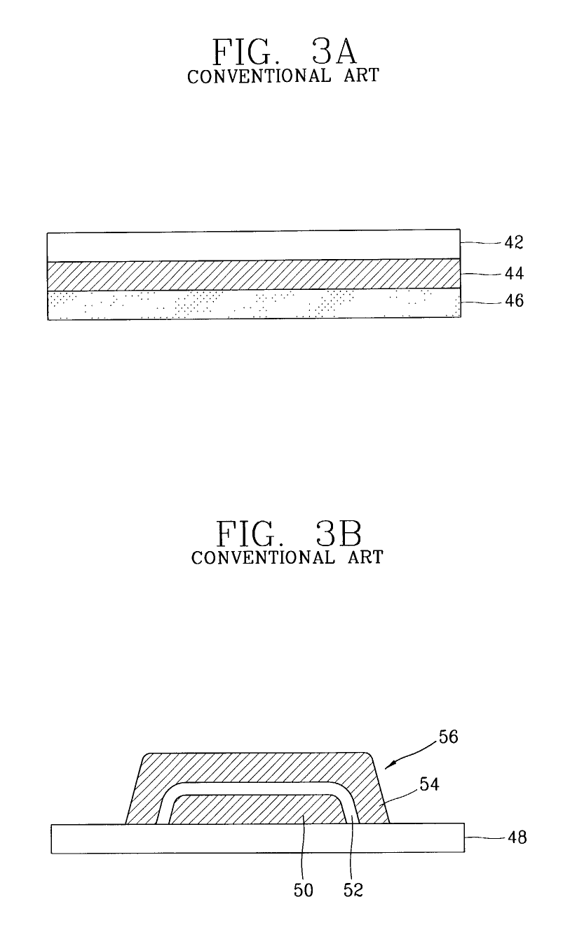

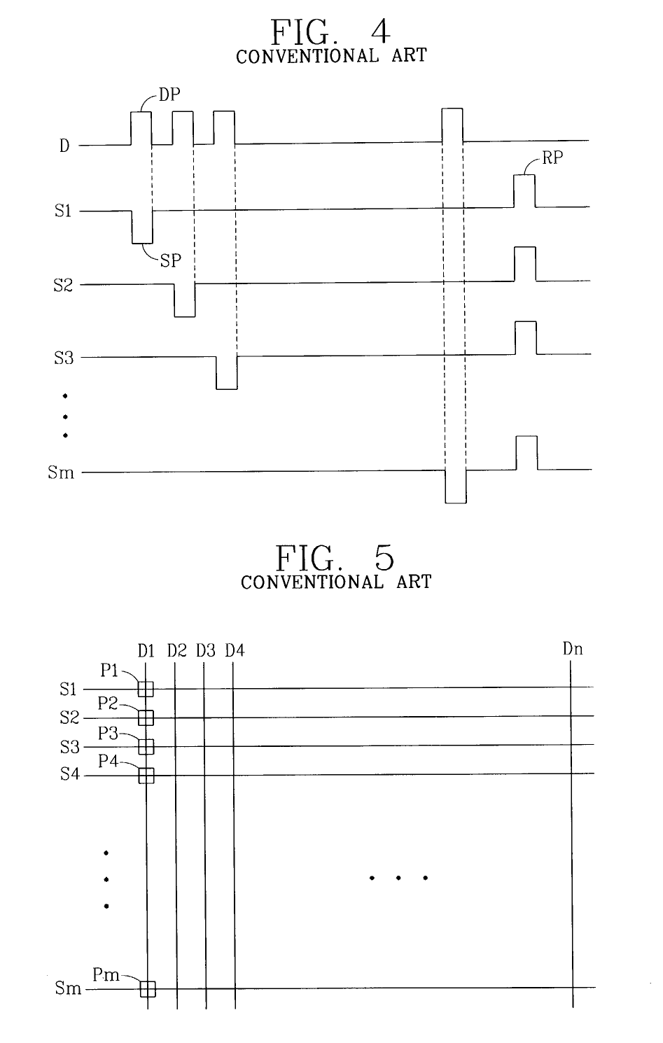

On the other hand, FIG. 10 displays the data pulse when the gate electrode is used as a data electrode. If a cathode electrode is used as data electrode, a pulse whose polarity is reversed from FIG. 1 is supplied.

FIG. 11 is a view showing a voltage value which is applied to a scan electrode by the driving apparatus shown in FIG. 8.

As shown in FIG. 11, the voltage which is supplied to the scan electrode S1˜Sm gradually become lower by the components of the scan electrodes S1˜Sm and the voltage which is supplied to the data electrodes D1˜Dn gradually become higher by the reference voltage which becomes gradually higher. Therefore, an average voltage which is supplied from the scan electrodes S1˜Sm and data electrodes D1˜Dn becomes uniform in all pixel cells. That is, voltage drop of the scan electrodes S1˜Sm can be compensated by supplying the reference voltage which becomes gradually higher and a picture having a uniform luminance is displayed in the panel 118.

On the other hand, the width (pulse width modification) and/or amplitude (pulse amplitude modification) of the data pulse which is applied to the data electrode D is set differently according to the gray scale. For instance, when a high gray scale is displayed, width and/or amplitude of the data pulse DP is set wide or high and width and/or amplitude of the data pulse DP is set narrow or low when a low gray scale is displayed. That is, in the pulse width modifying method or the pulse amplitude modifying method, in case the whole screen of the FED is displayed white, a higher voltage is applied along from the first data electrode D1 to the nth data electrode Dn as shown in FIG. 10, and accordingly the voltage dropping components of the scan electrode S is compensated.

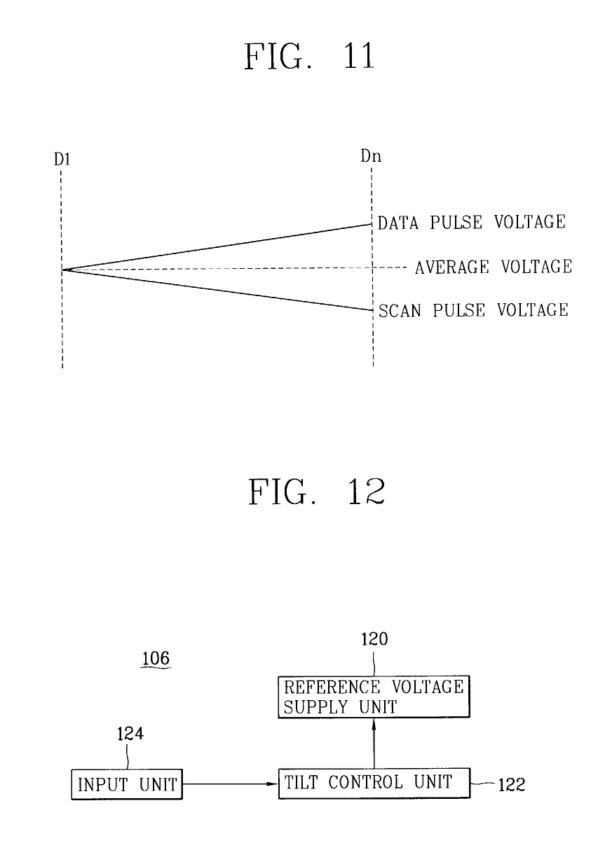

FIG. 12 is a block diagram showing the reference voltage signal generation unit shown in FIG. 8 in detail.

As shown in FIG. 12, the reference voltage generation unit 106 includes an input unit 124 for receiving a voltage dropping value of the scan electrode, a reference voltage supply unit 120 for generating a reference voltage having a predetermined tilt to compensate the voltage dropping value, and a tilt control unit 122 which is installed between the input unit 124 and reference voltage supply unit 120, for controlling the reference voltage generation unit. Hereinafter, the operation of the reference voltage generation unit 106 will be described in detail.

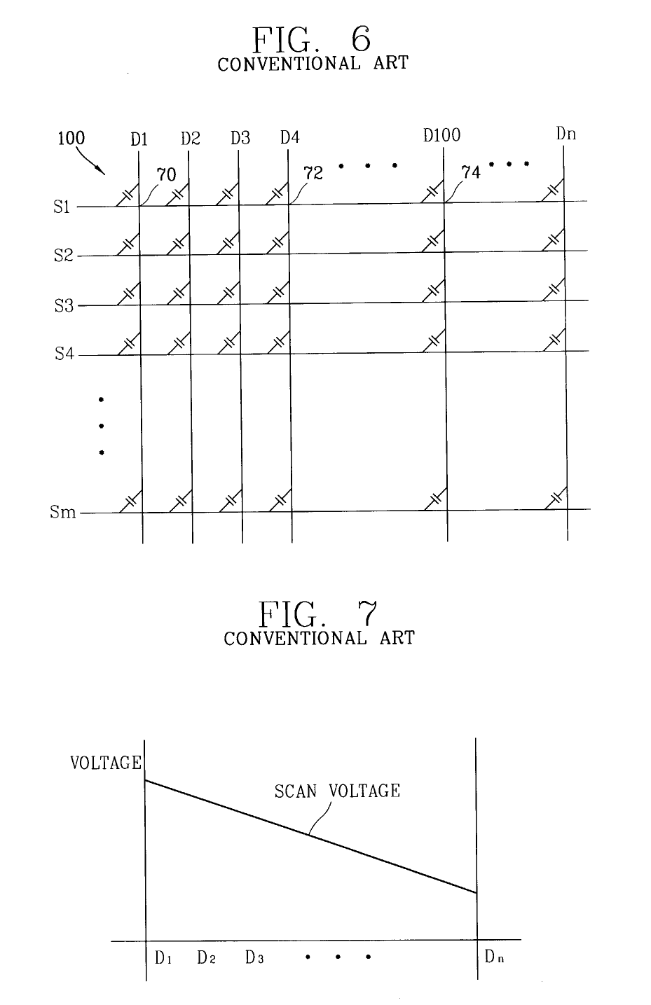

Firstly, the input unit 124 receives a voltage dropping value of the scan line S from a user. At this time, the user measures voltages of a first crossing of a first data electrode D1 and scan line, and a second crossing of a nth data electrode Dn and scan line S, as shown in FIG. 6. In case a voltage of 5V is measured in the first crossing and a voltage of 4V is measured in the second crossing, the user inputs the voltage dropping value of the scan line S of 1V to the input unit 124.

The voltage dropping value of the scan line S which is inputted to the input unit is inputted to the tilt control unit 122.

The tilt control unit 122 controls the reference voltage supply unit 120 to generate a reference voltage having a voltage difference of 1V. At this time, the reference voltage supply unit 120 generates a reference voltage which is gradually raised so that a voltage which is supplied to the nth data electrode has a voltage difference of 1V from the voltage supplied to the first data electrode D1 and supplies the reference voltage to the first and second data driving units 114A and 114B.

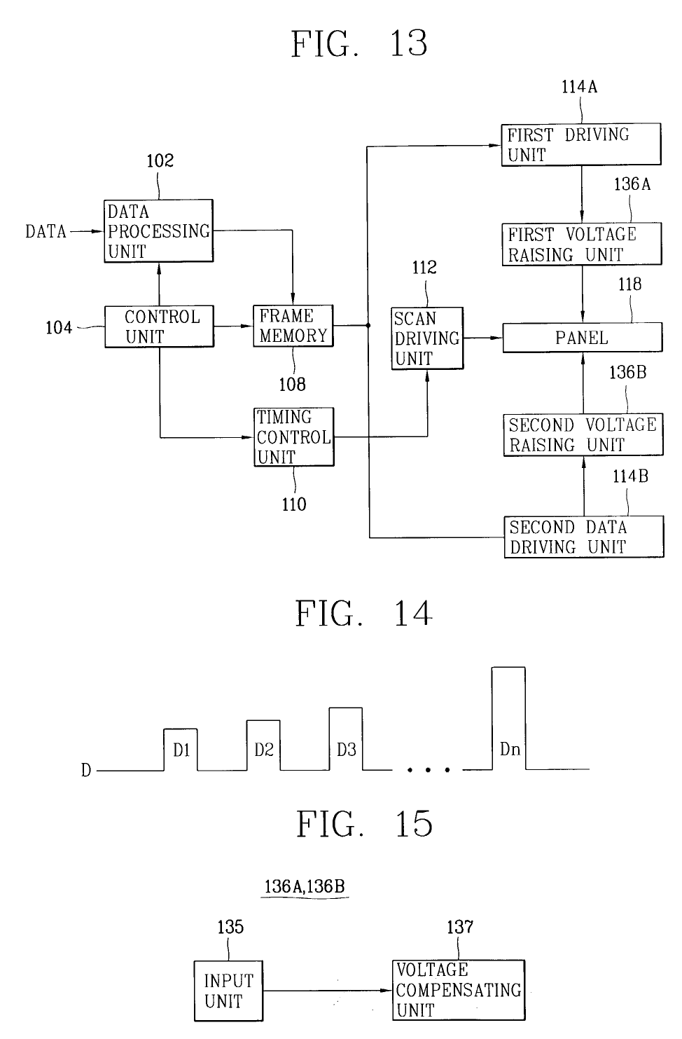

FIG. 13 is a block diagram showing the driving apparatus of the flat FED in accordance with the second embodiment of the present invention. The flat FED shown in FIG. 13 embodies a gray scale in the pulse amplitude pulse width modifying method.

As shown in FIG. 13, the driving unit of the flat FED in accordance with the second embodiment of the present invention includes a panel 118 for displaying an image, a data processing unit 102 for receiving data from the outside and supplying the data, a frame memory 108 for temporarily storing data outputted from the data processing unit 102, first and second data driving units 114A and 114B for generating a data pulse by receiving data stored in the frame memory 108, first and second voltage raising units 136A and 136B for raising voltage of the data pulse which is generated from the first and second data driving units 114A and 114B and supplying the raised data pulse to the panel 118, a timing control unit 110 for generating a timing control signal according to a control signal, a scan driving unit 112 for sequentially supplying the scan pulse to the panel 118 by controlling of the timing control signal, and a control unit 104 for generating the control signal. Hereinafter, the operation of the driving unit of the flat FED in accordance with the second embodiment of the present invention.

Firstly, the data processing unit 102 supplies the data supplied from the outside to the frame memory 108.

The frame memory 108 receives data corresponding to a frame from the data processing unit 102. The data corresponding to a frame, which is inputted to the frame memory 108 is supplied to the first and second data driving units 114A and 114B. The control unit 104 controls the data processing unit 102, frame memory 108 and timing control unit 110.

The timing control unit 110 generates a timing control signal and supplies the timing control signal to a scan driving unit 112. The scan driving unit 112 sequentially supplies a scan pulse to the panel 118 by receiving the timing control signal.

The data driving units 114A and 114B supply the data stored in the frame memory 108 to the first and second voltage raising units 136A and 136B.

The first and second voltage raising units 136A and 136B raise the voltage of the data pulse which is supplied from the first and second data driving units 114A and 114B and supply the raised data pulse to the panel 118. At this time, an image corresponding to the value of the gray scale of the data pulse is displayed in the panel 118.

On the other hand, the voltage which is raised in the first and second voltage raising units 136A and 136B is determined differently according to the position of the data lines D1˜Dn. That is, the first and second voltage raising units 136A and 136B apply a higher voltage along from the first data electrode D1 to the nth data electrode Dn. This will be described in detail with reference to FIG. 14.

FIG. 14 is a view showing the data pulse which is applied to the data electrode by the driving apparatus shown in FIG. 13.

As shown in FIG. 14, when a data pulse for displaying the whole screen of the FED is supplied from the first and second data driving unit 134A and 134B, a higher voltage is applied along from the first data electrode D1 to the nth data electrode Dn in the panel 118. That is, the amplitude of the data pulse is sequentially increased.

If a higher voltage is applied along from the first data electrode D1 to the nth data electrode Dn, voltage drop of the scan electrode S can be compensated as shown in FIG. 11.

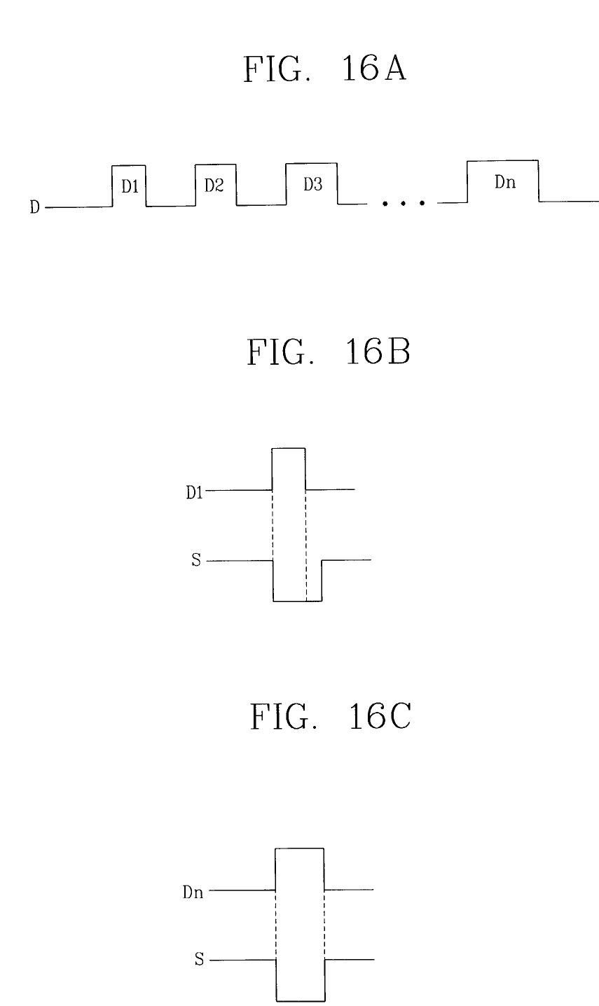

FIG. 15 is a block diagram showing a voltage raising unit which is shown in FIG. 13 in detail.

As shown in FIG. 15, the first and second voltage raising units 136A and 136B include an input unit 135 for receiving a voltage dropping value of the scan electrode from the outside, and a voltage compensating unit 137 for compensating a voltage of the data pulse which is supplied to the first and last data electrodes. Hereinafter, the operation of the voltage raising unit 136A and 136B will be described in detail.

Firstly, the input unit 135 receives a voltage dropping value of the scan line S from the user. At this time, the user measures voltages of a first crossing of a first data electrode D1 and scan line, and a second crossing of a nth data electrode Dn and scan line S, as shown in FIG. 6. In case a voltage of 5V is measured in the first crossing and a voltage of 4V is measured in the second crossing, the user inputs the voltage dropping value of the scan line S of 1V to the input unit 135.

The voltage dropping value of the scan line S of 1V which is inputted to the input unit 135 is inputted to the voltage compensating unit 137. The voltage compensating unit 137 raises the voltage of the data pulse so that the value inputted from the input unit 135, that is, the voltage difference of the voltages supplied from the first data electrode D1 to the nth data electrode Dn becomes 1V.

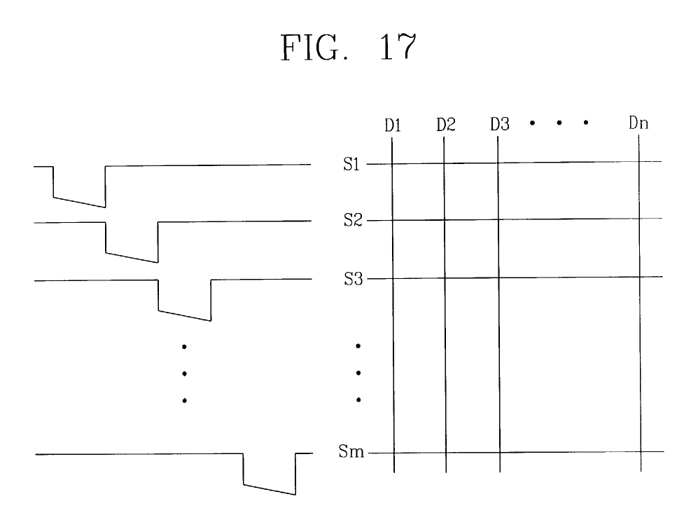

FIG. 16A is wave form view showing a driving wave form in accordance with the third embodiment of the present invention. The flat FED in the FIG. 16A embodies a gray scale in the pulse width modifying method.

As shown in FIG. 16A, the flat FED in accordance with the third embodiment of the present invention has different width of a data pulse when the whole screen of the FED is displayed white. That is, the data pulse has a wider pulse width along from the first data electrode D1 to the nth data electrode Dn. At this time, the pulse width of the scan pulse is set identically as shown in FIGS. 16B and 16C. That is, the pulse width of the scan pulse is set identically as the width of the data pulse which is applied to the nth data electrode Dn.

If the pulse width of the data pulse becomes wider along from the first data electrode D1 to the nth data electrode Dn, the voltage dropping component of the scan electrode S can be compensated.

FIG. 17 is a view showing a wave form of the scan pulse in accordance with the fourth embodiment of the present invention.

As shown in FIG. 17, a scan pulse having a predetermined tilt is supplied to the scan electrodes S1˜Sm of the flat FED in accordance with the fourth embodiment of the present invention. At this time, the tilt of the scan pulse is set so that a higher voltage can be applied along from the first data electrode D1 to the nth data electrode Dn. When the tilt of the voltage of the scan electrodes S1˜Sm is set so that a higher voltage can be applied along from the first data electrode D1 to the nth data electrode Dn, the voltage dropping component of the scan electrode S can be compensated.

As described above, a voltage dropping component of the scan electrode S can be compensated by setting the width and/or amplitude of the data pulse differently by the flat FED and driving method for the same in accordance with the present invention. Also, the voltage dropping component of the scan line can be compensated by setting the scan pulse to have a predetermined tilt. The flat FED and the driving method for the same in accordance with the present invention can display a picture having a uniform luminance by compensating the voltage dropping component of the scan line.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A driving method for a flat panel display device, comprising the steps of:
sequentially supplying a scan pulse to a plurality of scan electrodes; and
supplying a first data pulse which is synchronized with the scan pulse and has different voltage values to a plurality of data electrodes.

2. The method of claim 1, wherein the first data pulse have different voltage values to compensate a voltage dropping component of the scan electrode.

3. The method of claim 1, wherein the voltage value of the first data pulse is obtained by adding a voltage value of a reference voltage having a predetermined tilt and a voltage value of a second data pulse which has a same voltage value as the reference voltage.

4. The method of claim 3, wherein the voltage value of the reference voltage becomes higher along from a first data electrode to a last data electrode.

5. The method of claim 3, wherein the voltage value of the reference voltage is determined by the voltage dropping component of the first scan electrode and last scan electrode.

6. The method of claim 1, wherein the first data pulse is generated by raising the voltage value of the second data pulse which has the same voltage value.

7. The method of claim 6, wherein the raised voltage value becomes higher along from a first data electrode to a last data electrode.

8. The method of claim 6, wherein the raised voltage value is determined by a voltage dropping component of the scan electrode.

9. The method of claim 7, wherein the first data electrode is formed near from the scan driving unit for supplying the scan pulse.

10. A driving method for a flat panel display device, comprising the steps of:
sequentially supplying a scan pulse to a plurality of scan electrodes; and
supplying data pulses which are synchronized with the scan pulse and have different pulse widths to a plurality of data electrodes.

11. The method of claim 10, wherein the data pulses have different pulse widths to compensate a voltage dropping component of the scan electrodes.

12. The method of claim 11, wherein the pulse width of the data pulse is increased along from a first data electrode to a last data electrode.

13. The method of claim 12, wherein the first data electrode is formed near from a scan driving unit for supplying the scan pulse.

14. The method of claim 12, wherein the pulse width of the data pulse which is supplied to the last data electrode is same as the pulse width of the scan pulse.

15. A driving method for a flat panel display device, comprising the steps of:
supplying a data pulse to a plurality of data electrodes; and
sequentially supplying scan pulses which are synchronized with the data pulse and have a predetermined tilt to a plurality of scan electrodes.

16. The method of claim 15, wherein the voltage of the scan pulse is increased along from a first data electrode to a last data electrode.

17. The method of claim 16, wherein the first data electrode is formed near from a scan driving unit for supplying the scan pulse.

18. A flat panel display device, comprising:
a reference voltage generation unit for generating a reference voltage value;
a scan driving unit for supplying a scan pulse to a scan electrode of the panel;
a data driving unit which is synchronized with the scan pulse, for supplying a data pulse obtained by adding the reference voltage value, to a data electrode of a panel; and
a timing control unit for controlling timing of the scan pulse.

19. The device of claim 18, wherein the reference voltage value has a predetermined tilt.

20. The device of claim 18, wherein the data pulse which is supplied from the data driving unit is obtained by adding the reference voltage having a predetermined tilt and a voltage value of the data pulse having an identical voltage value as the reference voltage.

21. The device of claim 18, wherein the reference voltage value is increased along from a first data electrode to a last data electrode.

22. The device of claim 21, wherein the first data electrode is formed near from the scan driving unit.

23. The device of claim 18, wherein the reference voltage generation unit includes:
an input unit for receiving a voltage dropping value of the scan electrode from an outside;
a reference voltage generation unit for generating a reference voltage having a predetermined tilt; and
a tilt controlling unit for controlling the reference voltage supply unit.

24. The device of claim 23, wherein the reference voltage generation unit generates the reference value having the predetermined tilt, to compensate a voltage dropping value of the scan electrode.

25. A flat panel display device, comprising:
a scan driving unit for supplying a scan pulse to a scan electrode of a panel;
a data driving unit which is synchronized with the scan pulse, for supplying a data pulse;
a timing control unit for controlling timing of the scan pulse; and
a voltage raising unit for raising voltage of a data pulse which is generated from the data driving unit and supplying the raised data pulse to a data electrode of the panel.

26. The device of claim 25, wherein the voltage raising unit adds a higher voltage to the data pulse along from a first data electrode to a last data electrode and supplies the added data pulse.

27. The device of claim 26, wherein the first data electrode is formed near from the scan driving unit.

28. The device of claim 25, wherein the voltage raising unit includes:
an input unit for receiving a voltage dropping value of the scan electrode from the outside; and
a voltage raising unit for compensating a voltage value of the data pulse which is supplied to first and last electrodes.

29. The device of claim 25, wherein the voltage raising unit sequentially increases a voltage of the data pulse which is supplied to a first data electrode and last data electrode to compensate voltage dropping value of the scan electrode.
